(19) United States
(12) Patent Application Publication
(10) Pub. No.: US 2019/0027110 A1
(43) Pub. Date: Jan. 24, 2019

(54) LIQUID CRYSTAL PANEL AND DEVICE

(71) Applicant: Shenzhen China Star Optoelectronics Semiconductor Display Technology Co., Ltd., Guangdong (CN)

(72) Inventor: Xianming ZHANG, Guangdong (CN)

(21) Appl. No.: 15/576,775

(22) PCT Filed: Aug. 29, 2017
(86) PCT No.: PCT/CN2017/099396

§ 371 Date: Nov. 24, 2017

(30) Foreign Application Priority Data
Jul. 19, 2017 (CN) 201710592473.9

(51) Int. Cl. G09G 3/36

(52) U.S. Cl. CPC G09G 3/3696; G09G 2330/021; G09G 2320/0204

(57) ABSTRACT

A liquid crystal display panel and a liquid crystal display device are provided. The liquid crystal display panel has an electric charge-sharing circuit connecting to the data lines, the electric charge-sharing circuit is configured to make the data lines be independent from each other when the liquid crystal display panel inputs data signals, and to connect all data lines to neutralize the electric charge of the data lines after all of the data signals of the liquid crystal display panel is inputted so that a variation of the electric charge for charging is reduced.

### FIELD OF THE DISCLOSURE

The present disclosure relates to a technical field of liquid crystal displays, and in particular to a liquid crystal display panel and a liquid crystal display device.

### BACKGROUND OF THE DISCLOSURE

To drive a panel, voltage VAA is provided to a source driver of the panel. As shown in FIG. 1, voltage VAA is provided from a power supply module 11. The power supply module 11 connects to the panel 13 through a flexible circuit board 12 of a chip on film (COF). Data lines output data signals by inputting voltage VAA to the data lines.

Number of columns of the data lines relate to the resolution. Number of columns of the data lines are fixed when the resolution of the panel is fixed. Inputting charge to the panel needs a transit of COF when the data lines are inputted voltage VAA.

Referring to FIG. 2, a charging process of a row of data lines is illustrated. A voltage changes from a high level voltage VH to a low level voltage VL, or a voltage changes from a low level voltage VL to a high level voltage VH. Variation of the electric charge is a larger range, and it causes a greater drive current of the COF.

As a result, it is necessary to provide a liquid crystal display panel and a liquid crystal display device for solving the problems existing in conventional technologies.

### SUMMARY OF THE DISCLOSURE

An object of the present disclosure is to provide a liquid crystal display panel and a liquid crystal display device so that a drive current can be reduced.

To achieve the above objects, the present disclosure provides a liquid crystal display panel, which comprises a plurality of data lines, a plurality of scanning lines, and a plurality of pixels defined by the data lines and the scanning lines. An electric charge-sharing circuit connects to the data lines, wherein the electric charge-sharing circuit is configured to make the data lines be independent from each other when the liquid crystal display panel inputs data signals, and to connect all data lines to neutralize the electric charge of the data lines after all of the data signals of the liquid crystal display panel are inputted so that a variation of the electric charge for charging is reduced. The electric charge-sharing circuit includes a plurality of first switches, and the date lines correspond to the first switches, respectively. An input terminal of the first switch connects to an end of the corresponding data line, the output terminals of all the first switches are connected to each other, and a control terminal of the first switch is configured to receive a control signal.

In the liquid crystal display panel of the present disclosure, the first switch is turned off when the data signal inputted to the liquid crystal display panel; the first switch is turned on when the liquid crystal display panel inputs data signals.

In the liquid crystal display panel of the present disclosure, the electric charge-sharing circuit further includes a control module connecting to the control terminal of the first switch configured to provide the control signal.

In the liquid crystal display panel of the present disclosure, the first switch is an n-channel FET, and the control signal is a low level signal when the liquid crystal display panel inputs data signals; the control signal is a high level signal when the liquid crystal display panel has input the data signals.

In the liquid crystal display panel of the present disclosure, the first switch is a p-channel FET, and the control signal is a high level signal when the liquid crystal display panel inputs data signals; the control signal is a low level signal when the liquid crystal display panel inputs data signals.

To achieve the above objects, the present disclosure provides a liquid crystal display panel, which comprises a plurality of data lines, and an electric charge-sharing circuit connecting to the data lines. The electric charge-sharing circuit is configured to make the data lines independent from each other when a data signal inputs to the liquid crystal display panel, and configured to turn on all data lines to neutralize the electric charge of the data lines when the liquid crystal display panel has input the data signals so that a variation of the electric charge for charging is reduced.

In the liquid crystal display panel of the present disclosure, the electric charge-sharing circuit includes a plurality of first switches corresponding to the data lines, an input terminal of the first switch connects to an end of the corresponding data line, the output terminals of all first switches are connected to each other, and a control terminal of the first switch is configured to receive a control signal.

In the liquid crystal display panel of the present disclosure, the first switch is turned off when the data signal inputs to the liquid crystal display panel; the first switch is turned on when the liquid crystal display panel has input the data signals.

In the liquid crystal display panel of the present disclosure, the electric charge-sharing circuit further includes a control module connecting to the control terminal of the first switch configured to provide the control signal.

In the liquid crystal display panel of the present disclosure, the first switch is an n-channel FET, and the control signal is a low level signal when the data signal inputs to the liquid crystal display panel; the control signal is a high level signal when the liquid crystal display panel has input the data signals.

In the liquid crystal display panel of the present disclosure, the first switch is a p-channel FET, and the control signal is a high level signal when the data signal inputs to the liquid crystal display panel; the control signal is a low level signal when the liquid crystal display panel has input the data signals.

In the liquid crystal display panel of the present disclosure, the electric charge-sharing circuit further includes a plurality of second switches, each of the second switches is disposed between two adjacent data lines, an input terminal and an output terminal of the second switch correspond to the adjacent data lines, respectively, and a control terminal of the second switch is configured to receive a control signal.

To achieve the above objects, the present disclosure provides a liquid crystal display device, which comprises a liquid crystal display panel. The liquid crystal display panel comprises a plurality of data lines, and an electric charge-sharing circuit connecting to the data lines. The electric charge-sharing circuit is configured to make the data lines independent from each other when a data signal inputs to the liquid crystal display panel, and configured to turn on all data lines to neutralize the electric charge of the data lines when the liquid crystal display panel has input the data signals so that a variation of the electric charge for charging is reduced.

In the liquid crystal display device of the present disclosure, the electric charge-sharing circuit includes a plurality of first switches corresponds to the data lines, an input terminal of the first switch connects to an end of the corresponding data line, the output terminals of all first switches are connected to each other, and a control terminal of the first switch is configured to receive a control signal.

In the liquid crystal display device of the present disclosure, the first switch is turned off when the data signal inputs to the liquid crystal display panel; the first switch is turned on when the liquid crystal display panel has input the data signals.

In the liquid crystal display device of the present disclosure, the electric charge-sharing circuit further includes a control module connecting to the control terminal of the first switch configured to provide the control signal.

In the liquid crystal display device of the present disclosure, the first switch is an n-channel FET, and the control signal is a low level signal when the data signal inputs to the liquid crystal display panel; the control signal is a high level signal when the liquid crystal display panel has input the data signals.

In the liquid crystal display device of the present disclosure, the first switch is a p-channel FET, and the control signal is a high level signal when the data signal inputs to the liquid crystal display panel; the control signal is a low level signal when the liquid crystal display panel has input the data signals.

In the liquid crystal display device of the present disclosure, the electric charge-sharing circuit further includes a plurality of second switches, each of the second switches is disposed between two adjacent data lines, an input terminal and an output terminal of the second switch correspond to the adjacent data lines, respectively, and a control terminal of the second switch is configured to receive a control signal.

In the liquid crystal display panel and the liquid crystal display device of the present disclosure, the electric charge-sharing circuit is disposed on the panel. The data lines can be connected to each other to neutralize the electric charge of the data lines after all of the data signals of the liquid crystal display panel is inputted so that a variation of the electric charge for charging is reduced, and a drive current is reduced.

### DESCRIPTION OF THE DRAWINGS

FIG. 1 is a schematic view of a structure of a conventional liquid crystal display panel.

FIG. 2 is a waveform chart of a conventional charging process.

FIG. 3 is a schematic view of a structure of a liquid crystal display panel of an embodiment of the present disclosure.

FIG. 4 is a schematic view of a preferred structure of a liquid crystal display panel of an embodiment of the present disclosure.

FIG. 5 is a waveform chart of a charging process.

FIG. 6 is a schematic view of a structure of a liquid crystal display panel of another embodiment the present disclosure.

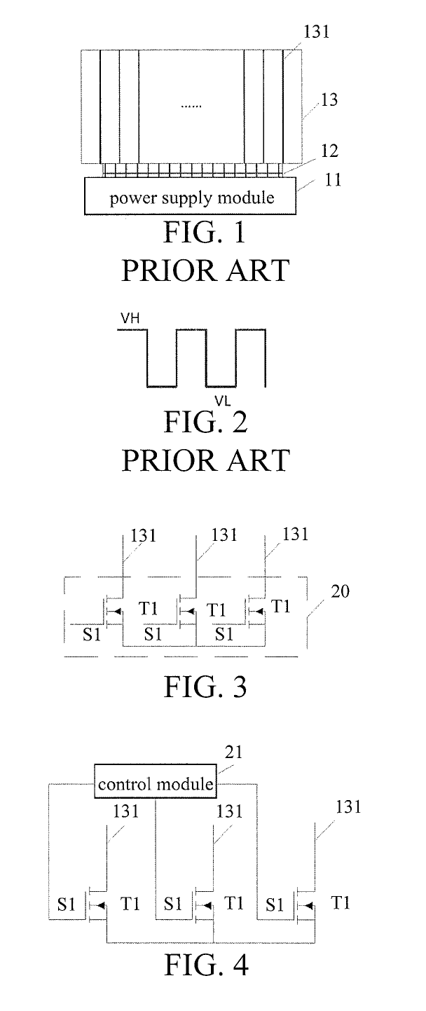

### DETAILED DESCRIPTION OF THE PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

Referring to FIG. 3, a liquid crystal display panel of an embodiment of the present disclosure is provided, which comprises a plurality of data lines 131, a plurality of scanning lines (not shown), and a plurality of pixels (not shown) defined by the data lines and the scanning lines. The liquid crystal display further comprises an electric charge-sharing circuit 20. The electric charge-sharing circuit 20 connects to the data lines 131. The electric charge-sharing circuit 20 is configured to make the data lines 131 be independent from each other when the liquid crystal display panel inputs data signals, and to connect all data lines to neutralize the electric charge of the data lines 131 after all of the data signals of the liquid crystal display panel are inputted, so that a variation of the electric charge for charging is reduced, and a drive current is reduced.

In an embodiment, the electric charge-sharing circuit 20 includes a plurality of first switches T1, and the date lines 131 correspond to the first switches T1, respectively, wherein an input terminal of the first switch T1 connects to an end of the corresponding data line 131, a front end of the data lines 131 connect to a source driver, and the end of the data line 131 keeps away from the source driver. The output terminals of all first switches T1 are connected to each other, and a control terminal of the first switch T1 is configured to receive a control signal S1.

When the liquid crystal display panel inputs data signals, the first switch T1 is turned off to make the data lines 131 be independent from each other, wherein the data lines 131 disconnect from each other so that an independent data signal is inputted to each of the data lines 131.

When the liquid crystal display panel has input data signals, the first switch T1 is turned on to make the data lines 131 connected to each other so that the electric charge of the data lines 131 is neutralized, which means positive charges and the negative charges are neutralized. After voltage VAA is inputted, the voltage range is reduced by half.

In other words, an independent data signal is inputted to each of the data lines 131 when the liquid crystal display panel inputs data signals, and all of the data lines 131 are turned on when the liquid crystal display panel has input data signals. A preset voltage is inputted, and the preset voltage is voltage VAA.

Referring to FIG. 4, the electric charge-sharing circuit 20 further includes a control module 21, and the control module 21 connects to the control terminal of the first switch T1. The control module 21 is configured to provide the control signal S1, which means the first switch T1 is turned off or turned on through the control module 21.

In an embodiment, the first switch T1 is an n-channel FET. The control signal S1 is a low level signal when the liquid crystal display panel inputs data signals. The control signal is a high level signal when the liquid crystal display panel has input the data signals.

In an embodiment, the first switch T1 is a p-channel FET. The control signal S1 is a high level signal when the liquid crystal display panel inputs data signals; the control signal S1 is a low level signal when the liquid crystal display panel inputs data signals.

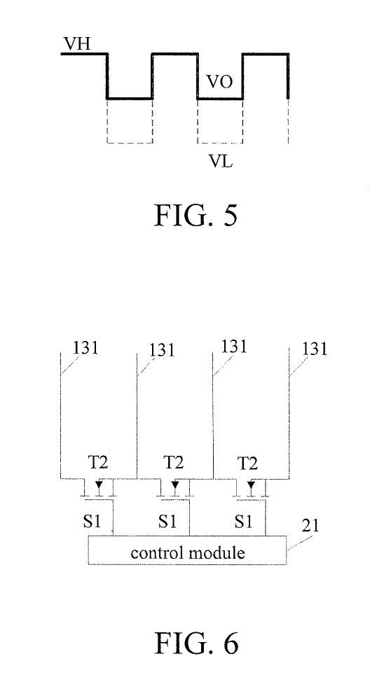

Referring to FIG. 5, after the panel is charged, the data lines are turned on with each other. A flexible circuit board of chip on film (COF) does not output and keep a high impedance state. The charge is between a high level voltage VH and a low level voltage VL. At the next time of charging, charging begins from V0. The voltage is changed from voltage VH to V0, or changed from V0 to voltage VH (shown as a solid line; the dotted line is a waveform chart of a conventional charging process). Therefore, a variation of the electric charge of positive and negative polarity is reduced by half so that the drive current provided from COF can be reduced effectively.

According to capacitive energy ½CΔV², when ΔV is reduced by half, parasitic capacitance loss is reduced by a quarter. Thus, the current VAA is reduced effectively, and the COF temperature is reduced with a higher resolution and a higher refresh rate.

In another embodiment, as shown in FIG. 6, the electric charge-sharing circuit 20 further includes a plurality of second switches T2, each of the second switches T2 is disposed between two adjacent data lines 131. An input terminal and an output terminal of the second switch T2 correspond to the adjacent data lines, respectively. For example, an input terminal of the second switch T2 at the left side connects to the first data line, and an output terminal of the second switch T2 at the left side connects to the second data line. A control terminal of the second switch T2 is configured to receive a control signal S1.

It is understood that the electric charge-sharing circuit 20 further includes a control module 21, and the control module 21 connects to a control terminal of the second switch T2. The control module 21 is configured to provide the control signal S1, which means the second switch T2 is turned off or turned on through the control module 21.

When the liquid crystal display panel inputs data signals, the second switch T2 is turned off to make the data lines 131 be independent from each other, wherein the data lines 131 disconnect to each other so that an independent data signal is inputted to each of the data lines 131.

When the liquid crystal display panel has input data signals, the second switch T2 is turned on to make the data lines 131 connected to each other so that the electric charge of the data lines 131 is neutralized, which means positive charges and the negative charges are neutralized. Thus the voltage range is reduced by half by inputting voltage VAA. The second switch T2 can be an n-channel FET or a p-channel FET. The specific working principle is the same as the previous embodiment, and is not described here.

A liquid crystal display device of an embodiment of the present disclosure is further provided, which comprises any of the above-mentioned liquid crystal display panels.

In the liquid crystal display panel and the liquid crystal display device of the present disclosure, the electric charge-sharing circuit is disposed on the panel. The data lines can be connected to each other to neutralize the electric charge of the data lines after all of the data signals of the liquid crystal display panel are inputted so that variation of the electric charge for charging is reduced, and drive current is reduced.

In summary, although the preferred embodiments of the present disclosure are disclosed above, but the above-described preferred embodiments are not intended to limit the disclosure, those of ordinary skill in the art, without departing from the spirit and scope of the present disclosure, can make various kinds of alterations and modifications, and the scope of the disclosure is defined by the scope of claims.

What is claimed is:

1. A liquid crystal display panel, comprising:
a plurality of data lines;
a plurality of scanning lines; and
a plurality of pixels defined by the data lines and the scanning lines;
an electric charge-sharing circuit connecting to the data lines, wherein the electric charge-sharing circuit is configured to make the data lines be independent from each other when the liquid crystal display panel inputs data signals, and to connect all data lines to neutralize a electric charge of the data lines after all of the data signals of the liquid crystal display panel are inputted so that a variation of the electric charge for charging is reduced;
wherein the electric charge-sharing circuit includes a plurality of first switches; the data lines correspond to the first switches, respectively, wherein an input terminal of the first switch connects to an end of the corresponding data line, the output terminals of all first switches are connected to each other, and a control terminal of the first switch is configured to receive a control signal.

2. The liquid crystal display panel according to claim 1, wherein the first switch is turned off when the data signal inputted to the liquid crystal display panel; the first switch is turned on when the liquid crystal display panel inputs data signals.

3. The liquid crystal display panel according to claim 1, wherein the electric charge-sharing circuit further includes a control module connecting to the control terminal of the first switch configured to provide the control signal.

4. The liquid crystal display panel according to claim 1, wherein the first switch is an n-channel FET, and the control signal is a low level signal when the liquid crystal display panel inputs data signals; the control signal is a high level signal when the liquid crystal display panel has input the data signals.

5. The liquid crystal display panel according to claim 1, wherein the first switch is a p-channel FET, and the control signal is a high level signal when the liquid crystal display panel inputs data signals; the control signal is a low level signal when the liquid crystal display panel inputs data signals.

6. A liquid crystal display panel, comprising:
a plurality of data lines; and
an electric charge-sharing circuit connecting to the data lines, wherein the electric charge-sharing circuit is configured to make the data lines independent from each other when a data signal is inputted to the liquid crystal display panel, and configured to turn on all data lines to neutralize the electric charge of the data lines when the liquid crystal display panel inputs data signals so that a variation of the electric charge for charging is reduced.

7. The liquid crystal display panel according to claim 6, wherein the electric charge-sharing circuit includes a plurality of first switches corresponds to the data lines, an input terminal of the first switch connects to an end of the corresponding data line, the output terminals of all first switches are connected to each other, and a control terminal of the first switch is configured to receive a control signal.

8. The liquid crystal display panel according to claim 7, wherein the first switch is turned off when the data signal inputs to the liquid crystal display panel; the first switch is turned on when the liquid crystal display panel has input the data signals.

9. The liquid crystal display panel according to claim 7, wherein the electric charge-sharing circuit further includes a control module connecting to the control terminal of the first switch configured to provide the control signal.

10. The liquid crystal display panel according to claim 7, wherein the first switch is an n-channel FET, and the control signal is a low level signal when the data signal inputs to the liquid crystal display panel; the control signal is a high level signal when the liquid crystal display panel has input the data signals.

11. The liquid crystal display panel according to claim 7, wherein the first switch is a p-channel FET, and the control signal is a high level signal when the data signal inputs to the liquid crystal display panel; the control signal is a low level signal when the liquid crystal display panel has input the data signals.

12. The liquid crystal display panel according to claim 6, wherein the electric charge-sharing circuit further includes a plurality of second switches, each of the second switches is disposed between two adjacent data lines, an input terminal and an output terminal of the second switch correspond to the adjacent data lines, respectively, and a control terminal of the second switch is configured to receive a control signal.

13. A liquid crystal display device, comprising:
a liquid crystal display panel, comprising:
a plurality of data lines; and
an electric charge-sharing circuit connecting to the data lines,
wherein the electric charge-sharing circuit is configured to make the data lines independent from each other when a data signal inputs to the liquid crystal display panel, and configured to turn on all data lines to neutralize the electric charge of the data lines when the liquid crystal display panel has input the data signals so that a variation of the electric charge for charging is reduced.

14. The liquid crystal display device according to claim 13, wherein the electric charge-sharing circuit includes a plurality of first switches corresponds to the data lines, an input terminal of the first switch connects to an end of the corresponding data line, the output terminals of all first switches are connected to each other, and a control terminal of the first switch is configured to receive a control signal.

15. The liquid crystal display device according to claim 14, wherein the first switch is turned off when the data signal inputs to the liquid crystal display panel; the first switch is turned on when the liquid crystal display panel has input the data signals.

16. The liquid crystal display device according to claim 14, wherein the electric charge-sharing circuit further includes a control module connecting to the control terminal of the first switch configured to provide the control signal.

17. The liquid crystal display device according to claim 14, wherein the first switch is an n-channel FET, and the control signal is a low level signal when the data signal inputs to the liquid crystal display panel; the control signal is a high level signal when the liquid crystal display panel has input the data signals.

18. The liquid crystal display device according to claim 14, wherein the first switch is a p-channel FET, and the control signal is a high level signal when the data signal inputs to the liquid crystal display panel; the control signal is a low level signal when the liquid crystal display panel has input the data signals.

19. The liquid crystal display device according to claim 13, wherein the electric charge-sharing circuit further includes a plurality of second switches, each of the second switches is disposed between two adjacent data lines, an input terminal and an output terminal of the second switch correspond to the adjacent data lines, respectively, and a control terminal of the second switch is configured to receive a control signal.
